(19) United States
(12) Patent Application Publication
(10) Pub. No.: US 2009/0108057 A1
(43) Pub. Date: Apr. 30, 2009

(54) Using Quick Response Codes to Provide Interactive Services

(76) Inventors: Hong Mu, Alhambra, CA (US); David Topolewski, Los Angeles, CA (US); Karl W. Scholz, Strafford, PA (US)

Correspondence Address: COURTNEY STANIFORD & GREGORY LLP, P.O. BOX 9686, SAN JOSE, CA, 95157, US

(21) Appl. No.: 12/258,064

(22) Filed: Oct. 24, 2008

Related U.S. Application Data
(60) Provisional application No. 60/982,243, filed on Oct. 24, 2007.

(51) Int. Cl. G06F 17/00

(52) U.S. Cl. 235/375

(57) ABSTRACT

Systems and methods are described that include using quick response (QR) codes with mobile devices for providing interactive applications and services to a user via the mobile devices. Embodiments use a scanner in the mobile device to scan the QR code of an object. The QR code or data of the QR code is transferred from the mobile device to a specific URL. A selected multimedia object corresponding to the QR code is retrieved from the URL or a database. The selected multimedia object is transferred to the mobile device for playback.

### RELATED APPLICATION

This application claims the benefit of U.S. Patent Application No. 60/982,243, filed Oct. 24, 2007.

### TECHNICAL FIELD

The present invention relates to the field of interactive learning using recognition of Quick Response (QR) codes, including, more particularly, real-time QR code recognition via client devices and coupled networks.

### BACKGROUND

Conventional systems and methods using QR code recognition include barcode scanners. In these conventional systems, a client device contains and processes all the components and/or applications required for QR code recognition activities. These components and/or applications include a scanner for scanning the QR code from a physical object. In these conventional systems and methods, the scanner application decodes the QR code and places the decoded data in memory; however, the decoded information may be sent to a remote computer or system. Although initially used for tracking parts in vehicle manufacturing, QR codes are now used in a much broader context spanning commercial tracking applications as well as convenience-oriented applications aimed at mobile device users. The use of QR code information in these conventional systems is therefore of limited value. Consequently, there is a need for a system and method supporting QR code recognition in which clients can scan a QR code of a book, magazine, newspaper, on a physical object, and/or on an electronic display to enable powerful value-added services for learning, such as offering audiovisual explanations, accepting speech for recognition and evaluation, games, playback of text, subtitles, and translations, to name a few.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 shows a client device configured to scan a QR code for use in interactive entertainment or interactive language learning applications, under an embodiment.

FIG. 2 is a block diagram of a system supporting QR code recognition processing between a client device and a server via a network coupling in interactive entertainment or interactive language learning applications, under an embodiment.

FIG. 3 shows transmission of a QR code to a server for processing in interactive entertainment or interactive language learning applications, under an embodiment.

FIG. 4 shows connection to URLs via a decoded QR code in interactive entertainment or interactive language learning applications, under an embodiment.

FIG. 5 is a flow diagram for a multimedia object playback thread, under an embodiment.

FIG. 6 is a flow diagram for processing a speech sample, under an embodiment.

FIG. 7 is a flow diagram for speech analysis, under an embodiment.

FIG. 8 is a flow diagram for speech recognition, under an embodiment.

FIG. 9 is a flow diagram for a speech response thread, under an embodiment.

### DETAILED DESCRIPTION

Methods and systems are described below for using QR codes on or in physical objects to launch interactive learning sessions when scanned with a client device having an optical sensing device or camera. The QR code recognition of an embodiment enables the provisioning of value-added services to a user in real-time or near real-time via client devices coupled to wired or wireless networks. The client devices include mobile and fixed devices, and the value-added services include, but are not limited to, advertising, gaming, learning exercises, visual playback, audio playback, examples, translations, and other activities, for use in entertainment and education applications.

In the following description, numerous specific details are introduced to provide a thorough understanding of, and enabling description for, the embodiments described herein. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

A QR code is a matrix code or two-dimensional bar code. QR codes can be used for a variety of purposes, including inventory control, and interactive functions, e.g., entertainment and interactive language learning, as described herein. For many of these purposes, including entertainment and interactive language learning, QR codes are used to determine what additional services to provide. For example, in an interactive language learning application, the application can provide animations, audio recordings, audiovisual recordings and playback, games, prizes, examples, feedback, and acceptance of audio input from a user. In this manner, the application program can provide added value to a user when they scan a QR code in a book or on a physical object or electronic display.

The system of an embodiment for supporting QR code recognition processing for learning activities such as language, math, sciences, history, etc., comprises one or more client devices or clients and a server. Each client of the system comprises a scanner component along with the corresponding or coupled scanning application configured to scan a QR code. Furthermore, each client may be configured to accept speech or audio data from a user of the client device. The client is also configured to store the QR code and audio data into one or more buffers or memory devices of the client or other remote devices coupled to the client. Each client is also configured to process information or data of the received QR code and audio data, the processing including but not limited to encoding, decoding, compressing, decompressing, encrypting, decrypting, and other data processing as appropriate to the data type being processed.

Each client of an embodiment is configured to transfer or transmit the scanned or received data (e.g., decoded QR code data, audio data, etc.). The client can also be configured to receive data from a remote device in response to the transmitted QR code data. For example, the client can transmit the QR code data and speech data to a remote server or specified uniform resource locator (URL), which then returns back a multimedia object or menu of additional choices. QR codes storing addresses and URLs may appear in books, on object packaging, games, toys or just about any object about which a user might want information.

Typically, the client will be configured to decode the QR code locally rather than transferring the QR code to the server for interpretation, but the client is not so limited. A user having a client device with a scanner, for example a camera telephone phone equipped with a reader and reader software can scan and decode the image of the QR code causing the phone's browser to launch and redirect to the programmed URL.

The server of the system of an embodiment is configured to receive either decoded QR code data or packets of encoded QR codes from one or more clients. In the latter case, the server is configured to decode each of the accepted QR code packets as they are received in order to regenerate the original QR code, and store the original QR code into one or more buffers associated with the client transmitting the packets of encoded QR codes. The server is configured to evaluate the QR code or QR code data from each of the clients, and in response to transmit a respective feedback response to each of the clients, for access by the client user. In addition, the server is configured to transmit a response to another client for display or use or to another server for additional processing.

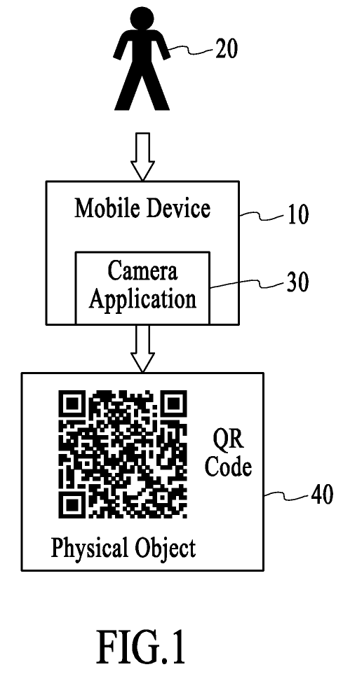

FIG. 1 shows a client device configured to scan a QR code, under an embodiment. The client device 10 is operated by a user 20 and includes and processes all applications corresponding to QR code recognition activities. These applications include a camera application 30 for scanning the QR Code from a physical object 40, but the applications are not so limited.

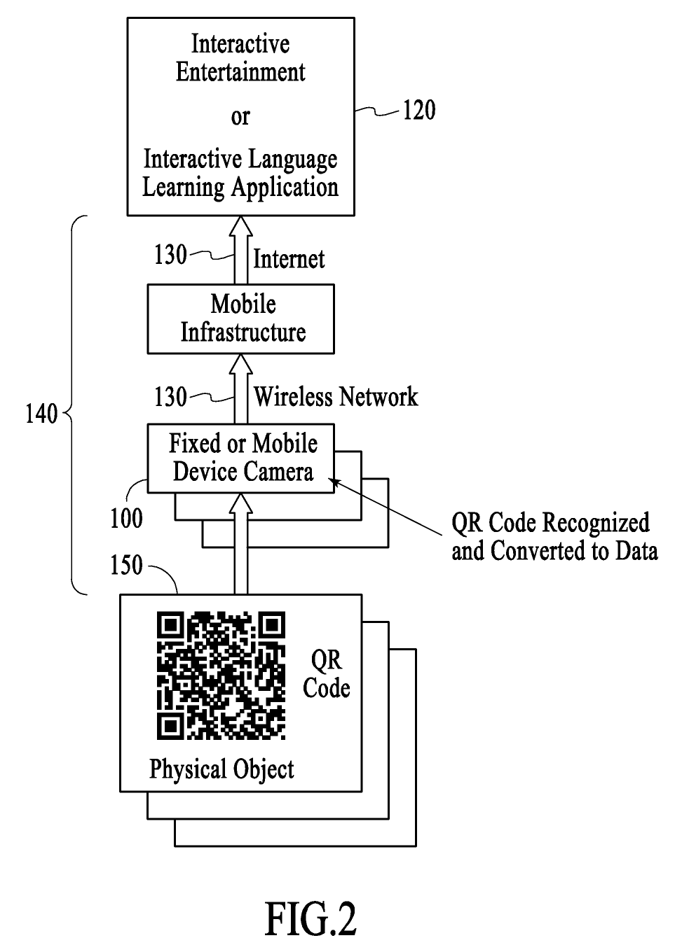

In an embodiment, QR code recognition processing is performed via a client device coupled to a server via a network to provide interactive entertainment or interactive language learning at the client device. In these embodiments, users use local processing devices (e.g., client devices) to communicate via one or more networks (e.g., Internet, wireless networks, wired networks, etc.) with a server supporting QR code recognition activities and exercises. FIG. 2 is a block diagram of a system supporting QR code recognition processing between a client device and a server via a network coupling, under an embodiment. The system includes a network 140 supporting QR code recognition. The network 140 includes, for example, a mobile infrastructure 130 comprising a client device 100 coupled or connected to one or more of wired networks, wireless networks, the Internet, and other network types 130 over which communication can occur. Numerous clients 100 can each communicate with a server 120 supporting QR code recognition services via the network 140, for example. In an embodiment, a client 100 is a mobile phone, personal digital assistant, personal computer, work station, or other device capable of scanning QR codes via an optical scanner from a user, playing an audio output stream via one or more speakers or other audio output device to a user, and communicating via the network 140, but is not so limited.

In an embodiment, to enable a client 100 to use QR code recognition for interactive entertainment, interactive learning, or interactive language learning over the mobile infrastructure 130, applications that support the processing of QR codes are downloaded from the server 120 and installed to the user's client 100 at the time a user subscribes to the entertainment or language learning service. These downloaded applications are subsequently run on the client 100 during the execution of the QR code recognition exercises.

When a user operating the client 100 wishes to communicate with the server 120 for QR code recognition activities, the user scans the QR code of the physical object or electronic display and transfers the QR code, or causes the QR code to be transferred, to the server 120 that supports QR code recognition processing. A browser running on the client 100 will establish a coupling or connection to the mobile infrastructure 130 (e.g., a W-CDMA, Transmission Control Protocol/Internet Protocol (TCP/IP) coupling or connection).

Information and messages are broken down into smaller pieces, or packets, to be transmitted from a source to a destination. The protocol breaks down and reassembles the packets, while ensuring the packets are transmitted to the proper destination. Each packet is given a header that contains a variety of information, including the order in which the packet is to be reassembled with other packets for the same transmitted message or information. Each packet is put into a separate IP envelope for transmission over the internet 130. The IP envelopes contain addressing information that direct the internet 130 where to a destination address. All IP envelopes containing packets for the same transmitted message or information have the same addressing information, in order that they are all transmitted to the same destination location, and thereafter, properly reassembled. Each IP envelope also contains a header that includes information such as the source, or client's, address, the destination address, the amount of time the packet should be maintained before being discarded, etc.

In an embodiment of a QR code recognition activity for interactive entertainment or language learning, a user requests, via their client, an XML (eXtensible Markup Language) file comprising a web page for use in a QR code function. The QR code function of an embodiment includes a QR code processing exercise from the server supporting QR code recognition. The QR code function of an embodiment also includes use of the URL from the decoded QR code to return a multimedia object or web page to the client. The proper XML file is returned to the client from the server, via the Internet or wireless network, and the client's browser displays the text, graphics and multimedia data of the file on the client's screen. The user may then perform various entertainment or language learning exercises at the direction of the displayed web page.

In order to support QR code recognition processing for interactive entertainment or interactive language learning via the Internet or wireless network, a user accesses the QR code recognition program on the device or a server, which may or may not be remotely located from the client. The user then scans the QR code using the client device and in response to the scanning, receives a response or feedback from the server. Responsive feedback from the QR code recognition program may be in the form of text, graphics, audio, audio/visual, or some combination of these but is not so limited.

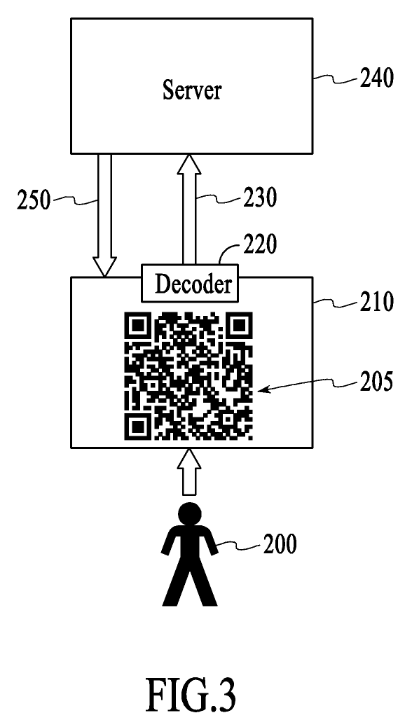

FIG. 3 shows transmission of QR code data to a server for processing in interactive entertainment or interactive language learning applications, under an embodiment. An embodiment of QR code recognition processing for interactive entertainment or interactive language learning begins when a user scans a QR code 205 using his/her client device. The QR code includes information or indications of a command for a location on the web or a server that the user wishes to access. The client decoder 220 sends the QR code data request to the server supporting the QR code processing application and the URL from the decoded QR code 230 via the network.

In response to transmission of the QR code by the client, the client receives an XML file 250 comprising a web page from the server for use in an entertainment or language learning activity, and the client device 210 displays the text, graphics and multimedia data of the file to the user 200. When the user thereafter selects an exercise via the displayed web page, a script associated with the selected exercise activates a browser component.

In an embodiment, a text response is returned to the client from the server, which is displayed on a portion of the screen already displaying the current web page for the activity accessed by the user. In an alternative embodiment, an entirely new XML page 250 is returned from the server 240, which is displayed as a new web page to the user, via the client screen on the mobile device 210.

As described above with reference to FIG. 2, in a network 140 supporting QR code recognition, numerous clients 100 are configured to communicate with a server 120 supporting QR code recognition services, e.g., for entertainment or language learning, via the Internet or wireless network 130. In an embodiment, in order to support QR code recognition processing for respective clients 100, the server 120 executes a QR code processing thread.

Generally, the QR code processing thread is configured to accept QR code data packets from a client, decode the QR code, and transmit a response, or appropriate feedback, to the client, to be provided to the user. The QR code processing thread is configured to perform each of these functions as the appropriate data becomes available to it, thereby eliminating any latencies that normally accrue when each of these functions is performed in a pipeline function, wherein processing of one function is required to complete before beginning other processing tasks.

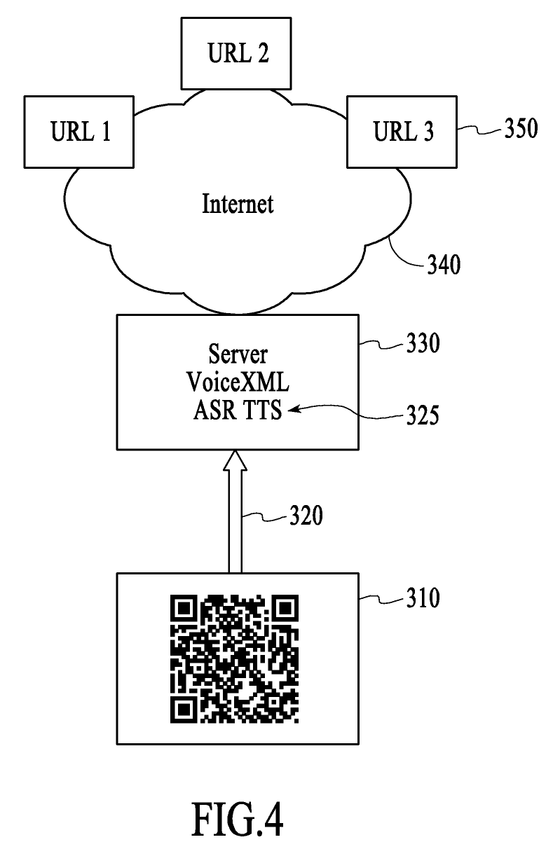

FIG. 4 shows connection to URLs via a decoded QR code in interactive entertainment or interactive language learning applications, under an embodiment. A QR code received by a client device is decoded 320 and transferred to a server where it is processed or analyzed by an instructional application (e.g., VoiceXML application), or interactive entertainment application. The processing can include processing using Automatic Speech Recognition (ASR) and Text-To-Speech (TTS) and/or pre-recorded audio when audio data is present. The application communicates through the network (e.g., internet 340) to access and exchange information with URLs 350 hosting a variety of content. In an embodiment of a QR code processing thread 320, a coupling or connection (e.g., TCP/IP connection) is established for a client 310 wishing to access the server 330. In response to the user scanning a QR code with the client 310, a client browser component is activated, and the client browser initiates and establishes the connection with the server. The connection established with the server includes connection or direction to a particular exercise or entertainment experience corresponding to the scanned QR code.

The server uses information of the QR code received from the client to determine what information to send to the client or to which site or portion of a site to direct the client. If the QR code does not indicate that speech data will be sent from the client, the QR code processing thread 320 on the server branches to other, non-speech, or conventional XML server, request processing 340. If, however, the client has indicated it will transmit speech data to the server, the QR code processing thread 310 establishes an instance of the speech recognition engine supported on the server 330, as well as a list of buffers for the client's input speech data 325. In an embodiment, appropriate software application(s), either commercial or proprietary, may be used as a speech recognition engine for speech recognition processing on the server.

In an alternative embodiment, the QR code is decoded by or within the client and the resulting URL is used by the client to make a connection.

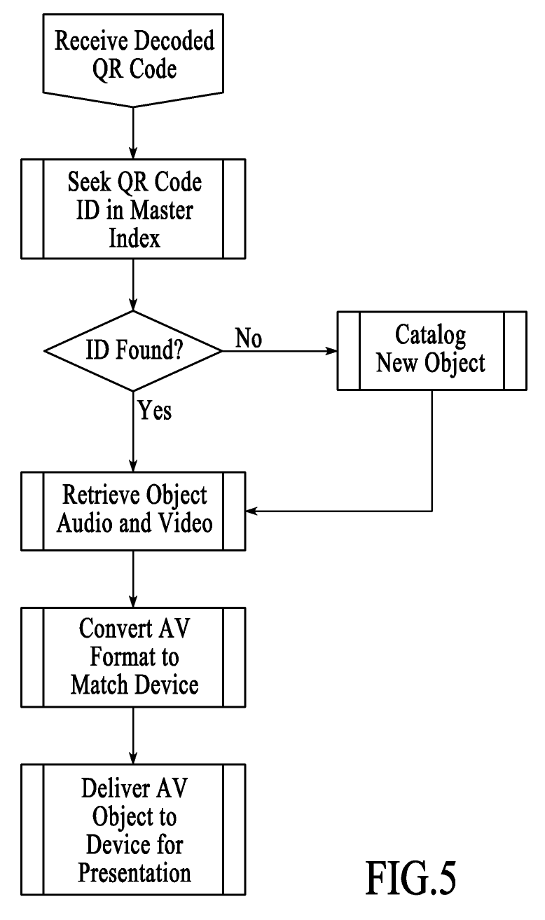

FIG. 5 is a flow diagram for a multimedia object playback thread, under an embodiment. Operation begins when the decoded QR code information is provided to or received at the server. The server determines if the received information is in the master index. If the received QR code information is not in the master index, the item is cataloged and quarantined for subsequent action. If the QR code information is identified in the master index, the audiovisual object is retrieved by the server, which then determines if a format conversion is necessary, performs such a conversion if needed, and then delivers the audiovisual object to the device for presentation.

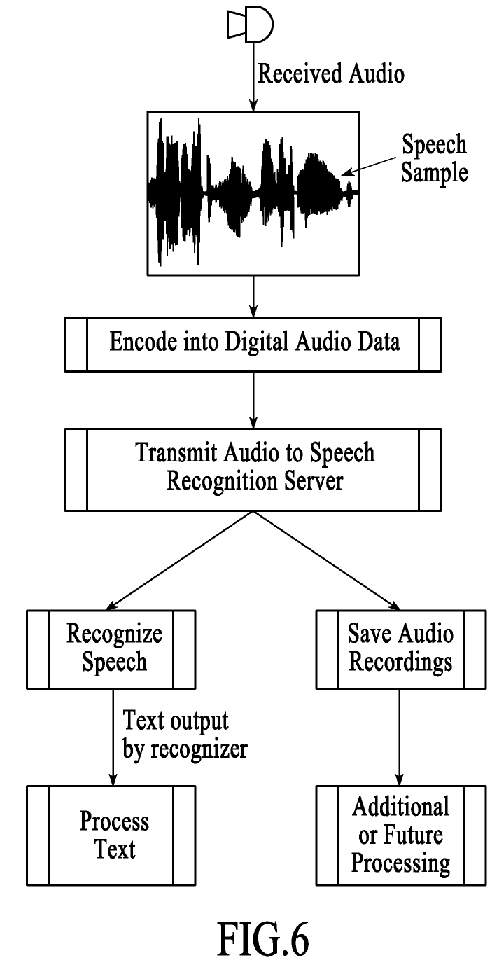

FIG. 6 is a flow diagram for processing a speech sample, under an embodiment. Operation begins when the speech sample is encoded into a digital format by the client device. The encoded data is transmitted over the coupled network to the speech recognition server. The encoded data of an embodiment is duplicated with one copy of the encoded data being sent to the speech recognition server (e.g., automatic speech recognizer (ASR)) for processing, and the other copy of the encoded data archived for future processing. The text returned from the ASR is provided to the VoiceXML browser for further processing.

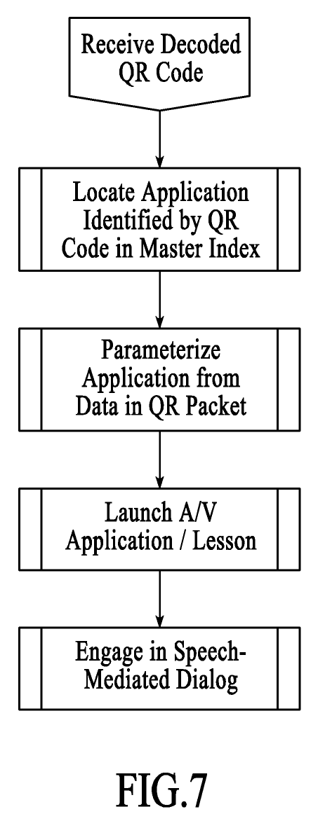

FIG. 7 is a flow diagram for speech analysis, under an embodiment. Operation begins when the decoded QR code data is provided or transferred to the server. The server is configured to locate the identified application using information of the QR code. For example, the server of an embodiment uses a look-up procedure in a master index to locate the identified application, but is not so limited. Data of the QR code defines the values of any parameters required by the application. Once the application is located, it is launched so that end user can begin a speech-mediated dialog.

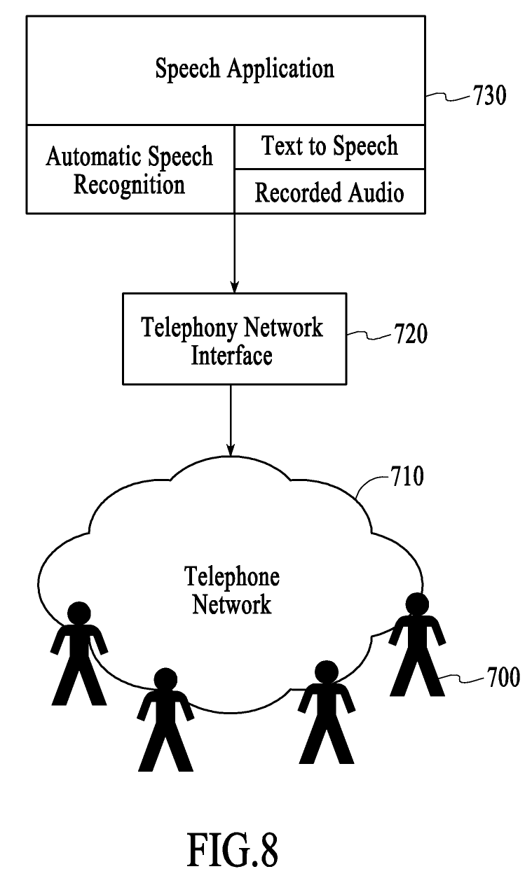

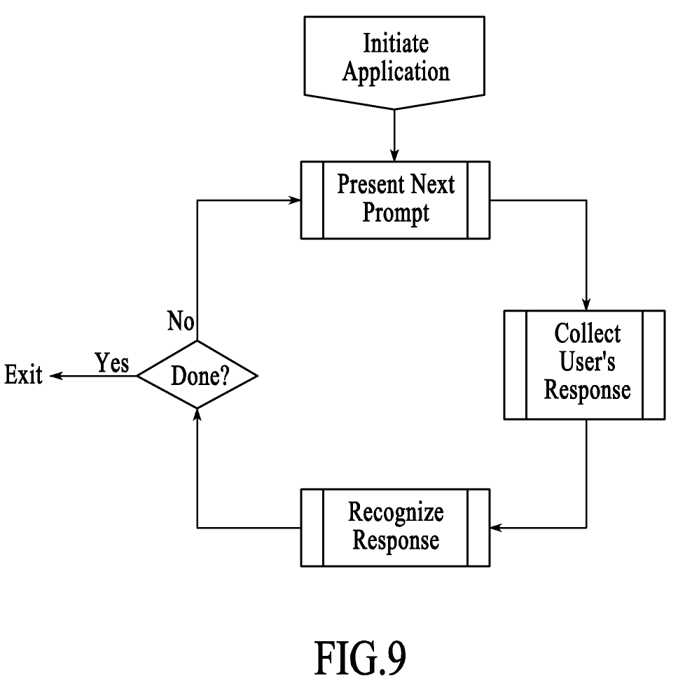

FIG. 8 is a flow diagram for speech recognition, under an embodiment. A speech recognition application is running under the server 730 of an embodiment, wherein the speech recognition application performs automatic speech recognition to process utterances and both text-to-speech and pre-recorded audio to provide audio feedback through the telephony network interface 720 to the telephone network (IP, SIP, mobile, W-CDMA, other 3G networks and their successors, fixed etc.) 710 to clients 700. FIG. 9 is a flow diagram for a speech response thread, under an embodiment.

The systems and methods described herein include a method for using QR codes with mobile devices for education and training services. The method of an embodiment uses an optical device or component hosted on or in a client device (e.g., mobile device) to scan the QR code of a card, portion of a book, portion of a magazine, portion of a newspaper, physical object, and/or display screen or device. The method of an embodiment decodes the QR code in the mobile device. The method of an embodiment transfers or transmits the decoded QR code data from the mobile device to a URL as determined from the QR code data. The method of an embodiment catalogs the QR code data. The method of an embodiment associates the decoded QR code to a multimedia object in a database. The method of an embodiment retrieves the corresponding multimedia object from the database. The method of an embodiment transfers the corresponding multimedia object retrieved or read from the database to the mobile device for playback. The method of an embodiment can also transfers the corresponding multimedia object retrieved or read from the database to another device for playback or input into another software program or service.

The method of an embodiment packages a multimedia object response based on the selection of the particular QR code. The method of an embodiment transmits the multimedia object through one or more transmission packets to the client. One or more input packets of the multimedia object of an embodiment are transmitted via a mobile network coupling or connection, and one or more transmission packets of the QR codes of an embodiment are transmitted to the client via the same network connection.

One or more input packets of the multimedia object of an embodiment are sent to the client for use in learning exercises, including language, sciences, games, and other subjects and skills to name a few.

The method of an embodiment identifies a multimedia file stored on the server based on receiving a QR code from the client. The method of an embodiment encodes the multimedia object file into a smaller file representation. The method of an embodiment packages the multimedia object file into one or more transmission packets. The method of an embodiment transmits each of the one or more transmission packets to the client.

The systems and methods described herein include a method for supporting QR code determination at a server. The method of an embodiment receives a first QR code from a first client remote from the server. The first QR code of an embodiment is a code known by the server. The method of an embodiment associates a first set of a plurality of buffers with the first client. The method of an embodiment generates a first instance of a QR code recognition engine for the first client. The method of an embodiment indicates a first multimedia object associated with the first QR code to the first instance of the QR code recognition engine.

The method of an embodiment receives a second QR code from a second client remote from the server. The second QR Code of an embodiment comprises a second multimedia object. The method of an embodiment associates a second set of a plurality of buffers with the second client. The method of an embodiment generates a second instance of the QR code recognition engine for the second client. The method of an embodiment indicates a second multimedia object associated with the second QR code to the second instance of the QR code recognition engine.

The systems and methods described herein include a method for using QR codes with mobile devices for education and training services. The method of an embodiment uses the optical device in the mobile device to scan the QR code of a card, portion of a book, portion of a magazine, portion of a newspaper, physical object, and/or display screen or device. The method of an embodiment transfers the decoded QR code from the mobile device to a specific URL. The method of an embodiment retrieves the selected multimedia object from the URL or database. The method of an embodiment transfers the selected multimedia object to the mobile device for playback.

Embodiments described herein include a method comprising: receiving data of a quick response (QR) code at a mobile device, the data of the QR code received from a scan of the QR code; transmitting the data of the QR code to a uniform resource locator (URL); selecting a multimedia object corresponding to the data of the QR code and retrieving the multimedia object via one of the URL and a database; and transmitting the multimedia object to the mobile device.

The method of an embodiment comprises receiving the multimedia object at the mobile device and presenting the multimedia object to a user via at least one of a display and an audio device of the mobile device.

The multimedia object of an embodiment corresponds to at least one of an interactive application and a learning application.

The mobile device of an embodiment is a personal computer (PC), personal digital assistant (PDA), cellular telephone, and camera.

The QR code of an embodiment is located on a card, print media, newspaper, magazine, book, physical object, device, and display screen.

The method of an embodiment comprises generating the data of the QR code by decoding the QR code at the mobile device.

The method of an embodiment comprises packaging the multimedia object based on the QR code. The method of an embodiment comprises transmitting the multimedia object to the mobile device using at least one transmission packet, wherein the at least one transmission packet of the multimedia object is transmitted to the mobile device via a mobile internet connection.

At least one packet including the QR code of an embodiment is transmitted from the mobile device to the server via the mobile internet connection.

Transmitting the multimedia object of an embodiment comprises: encoding a multimedia object file of the multimedia object into a file representation, wherein a size of the file representation is relatively smaller than a size of the multimedia object file; packaging the file representation of the multimedia object file into at least one transmission packet; and, transmitting each of the at least one transmission packets to the mobile device.

Embodiments described herein include a method comprising: scanning a quick response (QR) code using a component of a mobile device and receiving data of the QR code from the scan; decoding the QR code and generating data of the QR code; transmitting the data of the QR code to a uniform resource locator (URL); receiving the transmitted data of the QR code and associating the data of the QR code with a multimedia object in a database; retrieving the multimedia object from the database; and transmitting the multimedia object to at least one of the mobile device for playback and a remote device for at least one of playback, input into an application, and input into a service.

Embodiments described herein include a system comprising: a client device including a scanner, the client device receiving a quick response (QR) code via a scan of an object; and a server coupled to the client device via a network, the server receiving the QR code from the client device, the server identifying and retrieving a multimedia object corresponding to the QR code, and the server transmitting the multimedia object to the mobile device.

The mobile device of an embodiment decodes the QR code.

The server of an embodiment decodes the QR code.

The QR code of an embodiment is located on a card, print media, newspaper, magazine, book, physical object, device, and display screen.

The mobile device of an embodiment receives the multimedia object and presents the multimedia object to a user via at least one of a display and an audio device.

The mobile device of an embodiment is a personal computer (PC), personal digital assistant (PDA), cellular telephone, and camera.

The multimedia object of an embodiment corresponds to at least one of an 10 interactive application and a learning application.

The server packages the multimedia object of an embodiment based on the QR code, and transmits the multimedia object to the mobile device using at least one transmission packet.

The server of an embodiment transmitting the multimedia object to the mobile device comprises encoding a multimedia object file of the multimedia object into a file representation, packaging the file representation of the multimedia object file into at least one transmission packet, transmitting each of the at least one transmission packets to the mobile device.

Embodiments described herein include a method comprising: receiving at a server a first QR code from a first remote client, the first QR code being one known by the server; associating a first set of a plurality of buffers with the first remote client; generating a first instance of a QR code recognition engine for the first remote client; identifying a first multimedia object associated with the first QR code to the first instance of the QR code recognition engine; receiving a second QR code from a second remote client, the second QR Code comprising a second multimedia object; associating a second set of a plurality of buffers with the second remote client; generating a second instance of the QR code recognition engine for the second client; and identifying a second multimedia object associated with the second QR code to the second instance of the QR code recognition engine.

The systems and methods described herein include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, mobile telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

Components of the systems and methods described herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), WiMax networks, wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description, the words “comprise,” “comprising,” and the like are to be construed in an inclusive sense as opposed o an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods described herein is not intended to be exhaustive or to limit the systems and methods described to the precise form disclosed. While specific embodiments of, and examples for, the systems and methods described herein are described herein for illustrative purposes, various equivalent modifications are possible within the scope of other systems and methods, as those skilled in the relevant art will recognize. The teachings of the systems and methods described herein provided herein can be applied to other processing systems and methods, not only for the systems and methods described above.

The elements and acts of the various embodiments described above can be combined to provide further embodiments. These and other changes can be made to the systems and methods described herein in light of the above detailed description.

In general, in the following claims, the terms used should not be construed to limit the embodiments to the specific embodiments disclosed in the specification and the claims, but should be construed to include all systems that operate under the claims. Accordingly, the embodiments are not limited by the disclosure, but instead the scope of the embodiments is to be determined entirely by the claims.

While certain aspects of the embodiments are presented below in certain claim forms, the inventors contemplate the various aspects of the embodiments in any number of claim forms. Accordingly, the inventors reserve the right to add additional claims after filing the application to pursue such additional claim forms for other aspects of the embodiments described herein.

What is claimed is:

1. A method comprising:
receiving data of a quick response (QR) code at a mobile device, the data of the QR code received from a scan of the QR code;
transmitting the data of the QR code to a uniform resource locator (URL);
selecting a multimedia object corresponding to the data of the QR code and retrieving the multimedia object via one of the URL and a database; and
transmitting the multimedia object to the mobile device.

2. The method of claim 1, comprising receiving the multimedia object at the mobile device and presenting the multimedia object to a user via at least one of a display and an audio device of the mobile device.

3. The method of claim 1, wherein the multimedia object corresponds to at least one of an interactive application and a learning application.

4. The method of claim 1, wherein the mobile device is a personal computer (PC), personal digital assistant (PDA), cellular telephone, and camera.

5. The method of claim 1, wherein the QR code is located on a card, print media, newspaper, magazine, book, physical object, device, and display screen.

6. The method of claim 1, comprising generating the data of the QR code by decoding the QR code at the mobile device.

7. The method of claim 1, further comprising:
packaging the multimedia object based on the QR code; and
transmitting the multimedia object to the mobile device using at least one transmission packet, wherein the at least one transmission packet of the multimedia object is transmitted to the mobile device via a mobile internet connection.

8. The method of claim 7, wherein at least one packet including the QR code is transmitted from the mobile device to the server via the mobile internet connection.

9. The method of claim 1, wherein transmitting the multimedia object comprises:
encoding a multimedia object file of the multimedia object into a file representation, wherein a size of the file representation is relatively smaller than a size of the multimedia object file;
packaging the file representation of the multimedia object file into at least one transmission packet; and,
transmitting each of the at least one transmission packets to the mobile device.

10. A method comprising:
scanning a quick response (QR) code using a component of a mobile device and receiving data of the QR code from the scan;
decoding the QR code and generating data of the QR code;
transmitting the data of the QR code to a uniform resource locator (URL);
receiving the transmitted data of the QR code and associating the data of the QR code with a multimedia object in a database;
retrieving the multimedia object from the database; and
transmitting the multimedia object to at least one of the mobile device for playback and a remote device for at least one of playback, input into an application, and input into a service.

11. A system comprising:
a client device including a scanner, the client device receiving a quick response (QR) code via a scan of an object; and
a server coupled to the client device via a network, the server receiving the QR code from the client device, the server identifying and retrieving a multimedia object corresponding to the QR code, and the server transmitting the multimedia object to the mobile device.

12. The system of claim 11, wherein the mobile device decodes the QR code.

13. The system of claim 11, wherein the server decodes the QR code.

14. The system of claim 11, wherein the QR code is located on a card, print media, newspaper, magazine, book, physical object, device, and display screen.

15. The system of claim 11, wherein the mobile device receives the multimedia object and presents the multimedia object to a user via at least one of a display and an audio device.

16. The system of claim 11, wherein the mobile device is a personal computer (PC), personal digital assistant (PDA), cellular telephone, and camera.

17. The system of claim 11, wherein the multimedia object corresponds to at least one of an interactive application and a learning application.

18. The system of claim 11, wherein the server packages the multimedia object based on the QR code, and transmits the multimedia object to the mobile device using at least one transmission packet.

19. The system of claim 11, wherein the server transmitting the multimedia object to the mobile device comprises encoding a multimedia object file of the multimedia object into a file representation, packaging the file representation of the multimedia object file into at least one transmission packet, transmitting each of the at least one transmission packets to the mobile device.

20. A method comprising:
receiving at a server a first QR code from a first remote client, the first QR code being one known by the server;
associating a first set of a plurality of buffers with the first remote client;
generating a first instance of a QR code recognition engine for the first remote client;
identifying a first multimedia object associated with the first QR code to the first instance of the QR code recognition engine;
receiving a second QR code from a second remote client, the second QR Code comprising a second multimedia object;
associating a second set of a plurality of buffers with the second remote client;
generating a second instance of the QR code recognition engine for the second client; and
identifying a second multimedia object associated with the second QR code to the second instance of the QR code recognition engine.
